(19) United States
(12) Patent Application Publication
(10) Pub. No.: US 2020/0294162 A1
(43) Pub. Date: Sep. 17, 2020

(54) VALUE PREDICTION ERROR GENERATION SYSTEM

(71) Applicant: Opendoor Labs Inc., San Francisco, CA (US)

(72) Inventor: Zainul Shah, San Francisco, CA (US)

(21) Appl. No.: 16/352,110

(22) Filed: Mar. 13, 2019

(51) Int. Cl. G06Q 50/16; G06F 16/587; G06N 20/20

(52) U.S. Cl. CPC G06Q 50/163; G06N 20/20; G06F 16/587

(57) ABSTRACT

Systems, devices, media and methods are presented for generating a value prediction error for a real-estate property. In one example, a system receives one or more images of a real estate property and a value prediction relating to the current value of the real-estate property. The system analyzes the one or more images and value prediction using a machine learning model to generate a value prediction error. The system determines whether the value prediction error exceeds a predetermined value prediction error threshold, and based on determining that the value prediction error exceeds the predetermined value prediction threshold, computes a final value of the real-estate property by adjusting the value prediction using the value prediction error.

### TECHNICAL FIELD

Embodiments of the present disclosure relate generally to a real-estate property buying and selling system. More particularly, but not by way of limitation, the present disclosure addresses systems and methods for determining a value of a real-estate property based on images and additional data associated with the real-estate property.

### BACKGROUND

Sellers who desire to sell a given real-estate property need to assess the value of the real-estate property. Although tools exist for determining the value of a real-estate property, the accuracy of the tools is dependent on the inputs a given user provides. Buyers spend a great deal of time manually researching, computing and determining the correct valuation for their property, and even then, some values are incorrectly determined.

### BRIEF DESCRIPTION OF THE DRAWINGS

To easily identify the discussion of any particular element or act, the most significant digit or digits in a reference number refer to the figure number in which that element is first introduced.

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a networked system including a value prediction error system, according to some example embodiments.

FIG. 2 illustrates a machine learning training and generation process for two machine learning models, according to some example embodiments.

FIG. 3 is a flow diagram illustrating an example method for predicting the value of a real-estate property, according to some example embodiments.

FIG. 4 is a diagrammatic illustration of an interface of a real-estate property buying and selling system on a computing device, according to some example embodiments.

FIG. 5 is a diagrammatic representation of a machine in the form of a computer system within which a set of instructions may be executed for causing the machine to perform any one or more of the methodologies discussed herein, in accordance with some example embodiments.

FIG. 6 is block diagram showing a software architecture within which the present disclosure may be implemented, in accordance with example embodiments.

### DETAILED DESCRIPTION

The description that follows includes systems, methods, techniques, instruction sequences, and computing machine program products illustrative of embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Mis-valuation of real-estate property can significantly impact property owners and businesses. Various factors are relevant in assessing the value of a real-estate property. However, “curb appeal” is the single most important factor in determining the value of a real-estate property. Curb appeal refers to the visual attractiveness of a real-estate property. It may apply to the exterior of a building, as well as landscaping and outdoor fixtures. Curb appeal is twice as important than kitchen quality and nearly four times as important as the flooring and layout. The following paragraphs describe a system for generating a value prediction error for real-estate properties using information relating to the curb appeal of a real-estate property. The value prediction error may be used to adjust a predicted value of a real-estate property resulting in a more accurate prediction of the value of the real-estate property.

One aspect of the present disclosure describes a system for predicting the current value of a real-estate property. For example, given an image of a real-estate property (e.g., a building or other aspects of the real-estate property) and a value prediction of the real-estate property, the system uses a trained machine learning model to generate a value prediction error of the real-estate property. If the value prediction error falls within a predetermined threshold, the system computes a final value of the real-estate property by adjusting the value prediction using the value prediction error. Further details of the system are provided below.

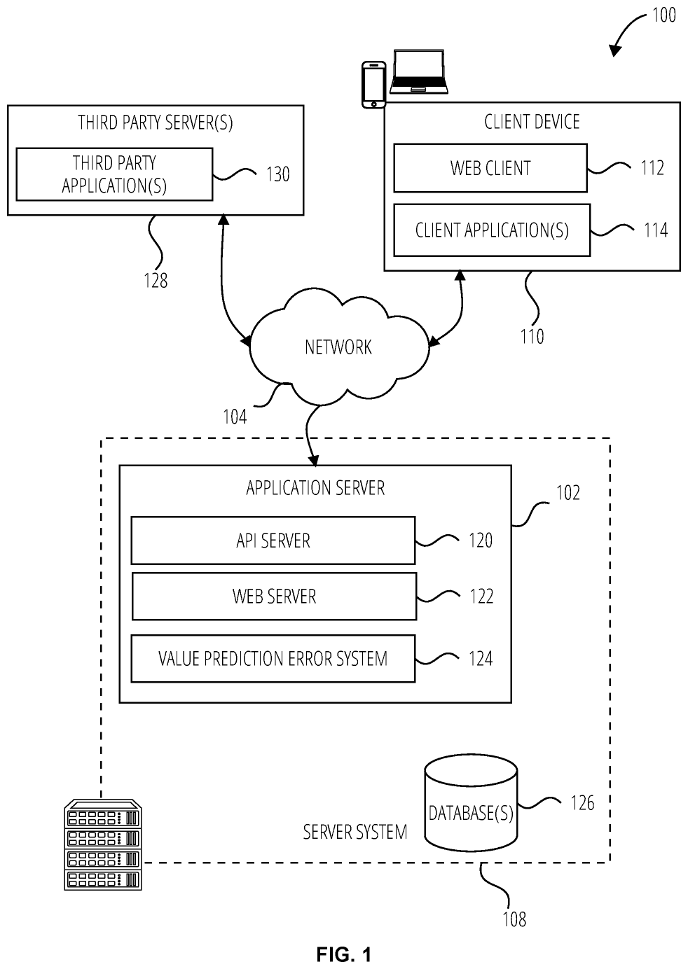

FIG. 1 is a block diagram illustrating a system 100, according to some example embodiments, configured to automatically determine the value of a real-estate property and provide the value to an interested entity (e.g., a user). The system 100 includes one or more client devices such as client device 110. The client device 110 comprises, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the system 100. In some embodiments, the client device 110 comprises a display module (not shown) to display information (e.g., in the form of user interfaces). In further embodiments, the client device 110 comprises one or more of touch screens, accelerometers, gyroscopes, cameras, microphones, global positioning system (GPS) devices, and so forth. The client device 110 may be a device of a user that is used to access and utilize real-estate property buying services (e.g., obtain a value prediction for a real-estate property). For example, the client device 110 may be used to input information to request an automated offer on a subject real-estate property, to request a value of a subject real-estate property, to request mortgage cost information, to request affordability information (e.g., how much a user can afford to spend on a given real-estate property), to make an offer on a subject real-estate property, to receive and display various information about a subject real-estate property or a market, and so forth.

For example, client device 110 is a device of a given user who would like to sell his or her subject real-estate property. Client device 110 accesses a website of the real-estate buying and selling service (e.g., hosted by server system 108). The user inputs an address of the subject real-estate property and selects an option to receive an automated offer or value of the subject real-estate property in the website. Server system 108 receives the request and identifies comps (e.g., a plurality of real-estate properties) having similar attributes as the subject real-estate property. Server system 108 automatically retrieves characteristics of the subject real-estate property based on the address and search for comps within a predetermined distance (e.g., 1.2 miles) of the address of the subject real-estate property. Server system 108 then automatically computes a value for the subject real-estate property and provides the value to the client device 110 instantly or after a period of time (e.g., 24 hours). In some circumstances, server system 108 involves an operator of a website of the real-estate buying and selling service using an operator device to review the value that was automatically computed before the value is returned to the client device 110. Client device 110 receives the value and provides an option to the user to complete the real-estate transaction.

For example, the user selects an option to complete the sale of the real-estate property. In response, server system 108 automatically generates a contract for sale of the subject real-estate property and allows the user to execute the contract to complete the sale. After the user executes the contract the subject real-estate property enters a pending status. Server system 108 may present a list of available closing dates to the user. Once the user selects the closing date, the subject real-estate property closes at the contract price on the closing date.

As another example, client device 110 is a device of a given user who would like to obtain a value prediction or value prediction error information regarding the valuation of a real-estate property. Client device 110 accesses a website of the real-estate buying and selling service (e.g., hosted by server system 108). The user inputs an address of the real-estate property, and, optionally, attaches an image of the real-estate property on the website. Server system 108 receives the user inputs and automatically estimates a value prediction error of the current valuation of the real-estate property. In one example, server system 108 also retrieves various other quantitative data specific to the target location (e.g., average real-estate property values, average cost of insurance, average taxes, average homeowner's association fees, square footage, number of bedrooms, etc.). For instance, the server system 108 computes the value prediction error based on one or more of the real-estate property and quantitative data regarding the real-estate property. The final value of the real-estate property is adjusted based on the value prediction error and provided by server system 108 to the client device 110.

One or more users may be a person, a machine, or other means of interacting with the client device 110. In example embodiments, the user may not be part of the system 100 but may interact with the system 100 via the client device 110 or other means. For instance, the user may provide input (e.g., touch screen input or alphanumeric input) to the client device 110 and the input may be communicated to other entities in the system 100 (e.g., third-party servers 130, server system 108, etc.) via the network 104. In this instance, the other entities in the system 100, in response to receiving the input from the user, may communicate information to the client device 110 via the network 104 to be presented to the user. In this way, the user interacts with the various entities in the system 100 using the client device 110.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser) or one or more client applications 114. The client device 110 may include one or more client application(s) 114 (also referred to as “apps”) such as, but not limited to, a web browser, messaging application, electronic mail (email) application, an e-commerce site application, a mapping or location application, an online home buying and selling application, a real-estate application, and the like.

In some embodiments, one or more client application(s) 114 are included in a given one of the client device 110, and configured to locally provide the user interface and at least some of the functionalities, with the client application(s) 114 configured to communicate with other entities in the system 100 (e.g., third-party third party server(s) 128, server system 108, etc.), on an as-needed basis, for data and/or processing capabilities not locally available (e.g., to access location information, to access market information related to real-estate properties, to authenticate a user, to verify a method of payment, etc.). Conversely, one or more client application(s) 114 may not be included in the client device 110, and then the client device 110 may use its web browser to access the one or more applications hosted on other entities in the system 100 (e.g., third party server(s) 128, server system 108, etc.

A server system 108 provides server-side functionality via the network 104 (e.g., the Internet or wide area network (WAN)) to one or more third party server(s) 128 and/or one or more client devices 110. The server system 108 includes an application program interface (API) server 120, a web server 122, and a value prediction error system 124, that may be communicatively coupled with one or more database(s) 126. The one or more database(s) 126 may be storage devices that store data related to users of the server system 108, applications associated with the server system 108, cloud services, housing market data, and so forth. The one or more database(s) 126 may further store information related to third party server(s) 128, third party application(s) 130, client device 110, client application(s) 114, users, and so forth. In one example, the one or more database(s) 126 may be cloud-based storage.

The API server 120 receives and transmits data between the client device 110 and the application server 102. Specifically, the API server 102 provides a set of interfaces (e.g., routines and protocols) that can be called or queried by the client application 114 to invoke functionality of the application server 112. The API server 102 exposes various functions supported by the application server 112, including account registration; login functionality; the sending of messages, via the application server 112, from a particular client application 114 to another client application 114; the sending of media files (e.g., images or video) from a client application 114 to the value prediction error system 124, for possible access by another client application 114; opening an application event (e.g., relating to the client application 114); generating and publishing data items; and so forth. The server system 108 may be a cloud computing environment, according to some example embodiments. The server system 108, and any servers associated with the server system 108, may be associated with a cloud-based application, in one example embodiment.

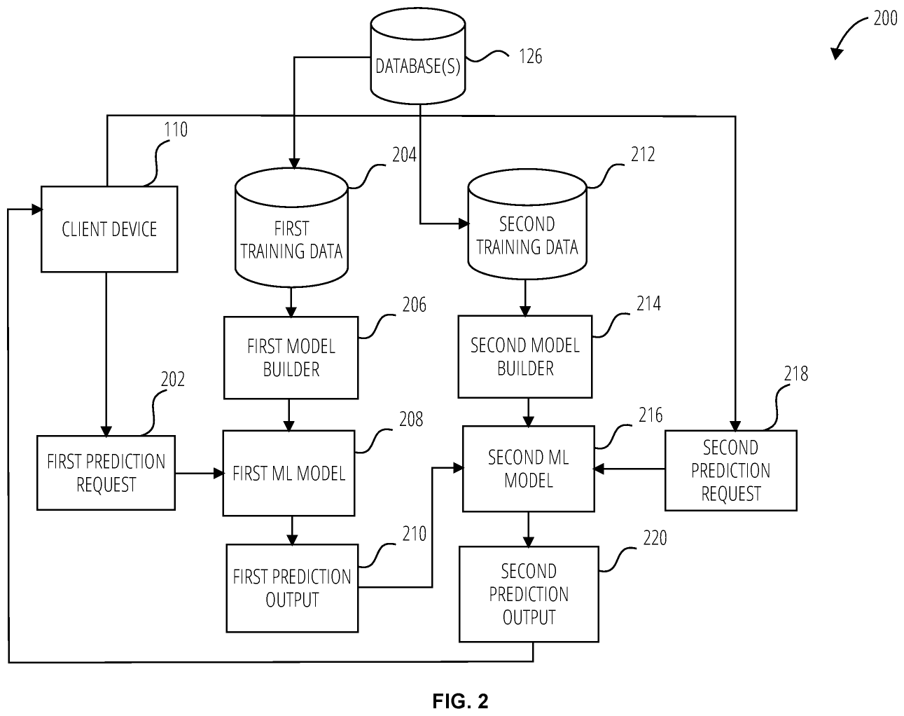

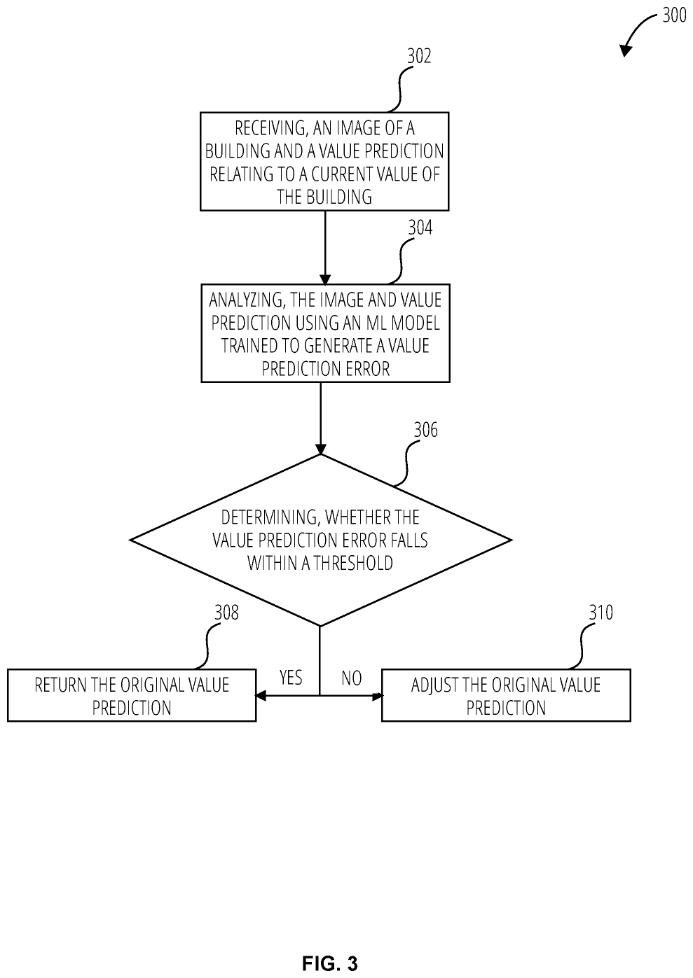

The server system 108 includes a value prediction error system 124. Value prediction error system 124 obtains one or more images of a real-estate property at a current address (e.g., street view images). The value prediction error system 124 computes an estimated value prediction error based on the images and the output of a second machine learning model trained to generate a value prediction of the real-estate property. In one example, the value prediction error system 124 comprises or uses one or more neural networks, such as a convolutional neural network (CNN). Further details of the value prediction. error system 124 are provided below in connection with FIG. 2 and FIG. 3.

The system 100 further includes one or more third party server(s) 128. The one or more third party server(s) 128 may include one or more third party application(s) 130. The one or more third party application(s) 130, executing on third party server(s) 128 may interact with the server system 108 via API server 120 via a programmatic interface provided by the API server 120. For example, one or more the third-party applications 132 may request and utilize information from the server system 108 via the API server 120 to support one or more features or functions on a website hosted by the third party or an application hosted by the third party. The third party application(s) 130, for example, may provide real-estate property valuation services that is supported by relevant functionality and data in the server system 108.

FIG. 2 is a block diagram illustrating an example machine learning modeling system 200 that may be part of the value prediction error system 124. The value prediction error system 124 may access a plurality of data such as images and structured data stored in one or more database(s) 126 that is used for training the first machine learning model 208 and second machine learning model 216. In one example, images for training are obtained by a third-party source (e.g., Google Images).

The first model builder 206 uses the first training data 204 (e.g., structured data) to train the first machine learning model to generate a prediction (e.g., value prediction). The first machine learning model 208 is tested for accuracy until a final first machine learning model 208 is trained and ready to use for prediction. A first prediction request module 202 receives a prediction request from the client device(s) 110 and inputs data corresponding to the request (e.g., square footage of the real estate property, number of bedrooms, number of bathrooms, etc.) into the first machine learning model 208 to generate a real-estate property value prediction for each request. The first prediction output module 210 provides the prediction output (e.g., the real-estate property value prediction) to the second machine learning model 216.

The second machine learning model 216 is trained by the second model builder 214. The second model builder 214 uses the second training data 212. (e.g., image data) to train the second machine learning model 216 (e.g., based on image recognition or similar technology) to generate a value prediction error. The machine learning model is tested for accuracy until a final second machine learning model 216 is trained and ready to use for prediction. A second prediction request module 218 receives prediction requests from the client device(s) 110 and inputs data corresponding to each request and the prediction output from the first prediction output module 210 (e.g., value prediction) into the second machine learning model 216 to generate a prediction error value.

In one example, the first machine learning model 208 consists of a convolutional neural network. The value prediction error system 124 may access a plurality of data relating to a real-estate property that may be stored as structured data in one or more databases 126 to be used for training the first machine learning model 208. The structured data (e.g. quantitative data) may include information corresponding to a real-estate property such as square footage, number of bedrooms, number of bathrooms, and so forth. The first machine learning model 208 analyzes the structured data items to generate a predicted value of the real-estate property.

In one example, the value prediction error is received from a second machine learning model 216 trained to generate an adjusted value prediction. The second machine learning model 216 may comprise a convolutional neural network. The value prediction error system 124 may access a plurality of images of various real-estate properties that is stored as image data in one or more databases 126 to be used for training the second machine learning model 216. In one example, the second training data 212 is a large-scale image classification dataset. The second machine learning model 216 receives a second prediction request 218 which may include an image of the real-estate property and also receives the value prediction generated by the first machine learning model 208 as input. The second machine learning model analyzes the image and the value prediction and generates a value prediction error. The image of the real estate property may comprise a panoramic image of the exterior of a real-estate property. In one example, the value prediction error is a signed integer (e.g., 2000 or −5000) or a percentage value (e.g., 5% or 10%).

In one example, the second machine learning model 216 is a pre-trained machine learning model that has been pre-trained on a large-scale image classification dataset. Because the second machine learning model 216 has already been trained on the image dataset, the second machine learning model is fine-tuned to analyze the input data (e.g., image of the real-estate property, value prediction output from the first machine learning model) and generate the value prediction error.

In another example, the second machine learning model 216 comprises a deep neural network. In this example, the second training data 212 may comprise a large set of structured data relating to real-estate properties. The second model builder 214 uses the structured data to train the second machine learning model 216 to generate a value prediction error. The second prediction request module 218 receives a request comprising structured data (e.g. quantitative data) corresponding to a real-estate property. The second machine learning model 216 analyzes the structured data to generate a value prediction error.

In another example, the second machine learning model 216 comprises a convolutional neural network and the second training data 212 comprises both image data and structured data. The second model builder 214 trains the second machine learning model 216 using the image data and structured data separately and combines results afterwards. In one example, the second prediction request module 218 receives a request comprising both an image and structured data (e.g. quantitative data) relating to a real estate property. In another example, the request may simply comprise location data related to the real-estate property and the value prediction error system 124 accesses one or more data sources to obtain one or more images and structured data corresponding to the real-estate property. In some example embodiments, the convolutional neural network includes additional layers for processing the structured data before combining the structured data with image data for additional data processing.

In another example embodiment, the second machine learning model 216 is pre-trained on a large-scale image classification data-set. The second model builder 214 trains the second machine learning modeluses training data 212 which comprises both image data and structured data.

FIG. 3 is a flow diagram illustrating an example method for predicting the value of a real-estate property, according to some example embodiments. In operation 302, the value prediction error system 124 receives one or more images of a real-estate property and a value prediction relating to a predicted current value of the real-estate property. In one example, the one or more images is received from a client device 110. For example, a user may request a value for a real-estate property and provide one or more images, or other data related to the real-estate property via the client device 110. In another example, the image is obtained or received from one or more database(s) 126 or via one or more other systems or data sources. For example, the image may be received by the value prediction error system 124 using location information for the real-estate property. For example, the value prediction error system 124 uses the address of a real-estate property to search through one or more database(s) 126 or other sources to retrieve one or more of the real-estate property. In operation 304, the value prediction error system 124 analyzes the one or more images and the value prediction (e.g., from the first machine learning model 208) using a second trained machine learning model 216 to generate a value prediction error.

In operation 306, the value prediction error system 124 determines whether the value prediction error falls within a predetermined threshold. In one example the predetermined threshold is a range of values (e.g., 1000-5000). In one example, the predetermined threshold is a percentage (e.g., 2%). For example, if the value prediction error system 124 determines a value prediction error does not exceed 2% (for example) of the value prediction, then the value prediction error system 124 does not adjust the final value of the real-estate property with the value prediction error, and instead returns the original value prediction, in operation 308.

If the value prediction error system 124 determines that the value prediction error is greater than 2% of the value prediction (e.g., does not fall into the predetermined threshold), then the value prediction error system 124 adjusts the final value of the real-estate property, as shown in operation 310, by factoring in the value prediction error into the calculation. For example, the value prediction error system 124 computes a final value of the real-estate property. Using a specific example, if the value prediction of the real-estate property is $300,000 and the value prediction error system 124 computes a value prediction error of negative $15,000, this value prediction error indicates that the real-estate property has been undervalued by $15,000. This value prediction error $15,000 is 5% of the value prediction of $300,000, and thus greater than the 2% value prediction error threshold. Accordingly, value prediction error system 124 adjusts the final value of the real-estate property by adding $15,000 to compute the final value of the real-estate property of $315,000.

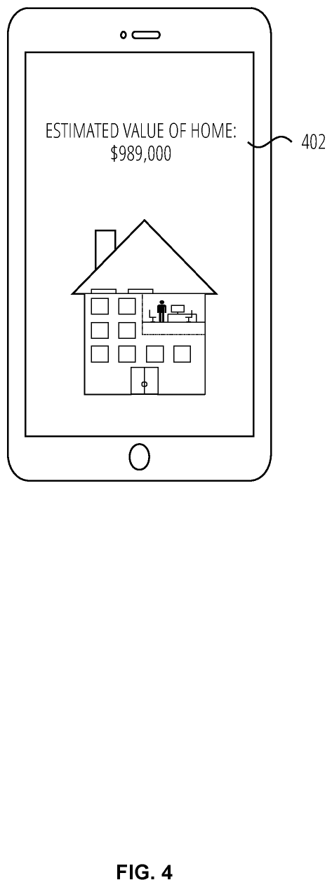

FIG. 4 is a diagrammatic illustration of an interface of a real-estate buying and selling system on a computing device (e.g., client device 110), according to some example embodiments. After the value prediction error system 124 computes the final value of the real-estate property, the value prediction error system 124 may provide the final value to one or more computing devices or computing systems. For example, the value prediction error system 124 may transmit the final value to a client device 110 and cause the final value to be displayed on a graphical user interface 402 of the client device 110. The estimated value of the home shown in the user interface 402 may be the adjusted value based on the value prediction error.

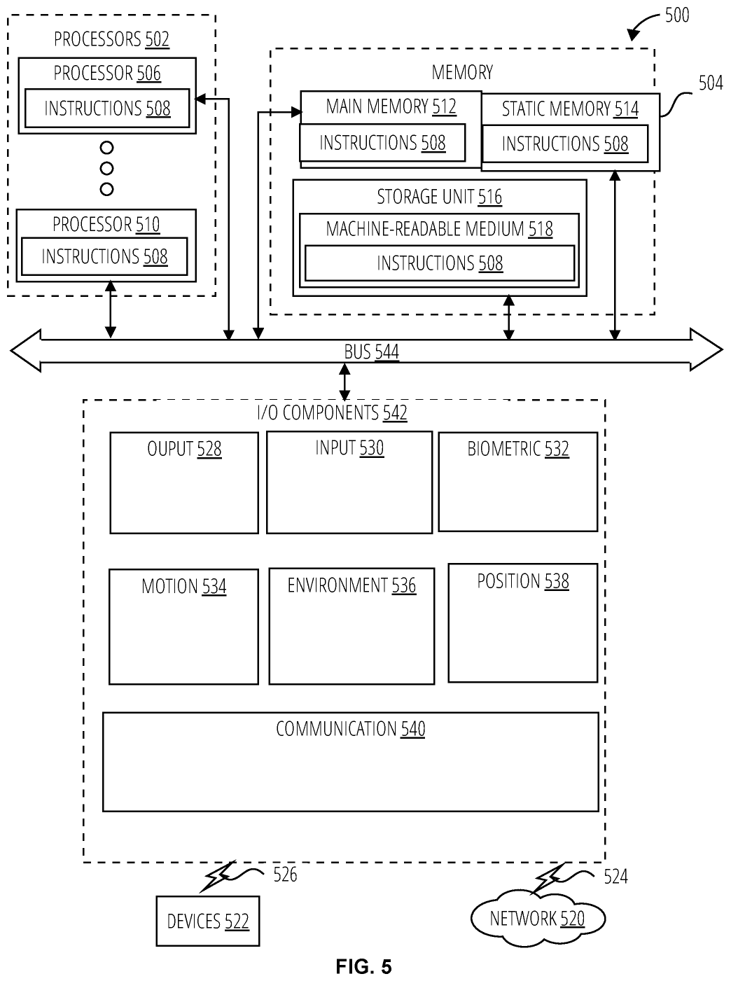

FIG. 5 is a diagrammatic representation of the machine 500 within which instructions 508 (e.g., software, a program, an application, an applet, an app, or other executable code) for causing the machine 500 to perform any one or more of the methodologies discussed herein may be executed. For example, the instructions 508 may cause the machine 500 to execute any one or more of the methods described herein. The instructions 508 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (SIB), a PDA, an entertainment media system, a cellular telephone, a smart phone, a mobile device, a wearable device (e.g., a smart watch), a smart home device (e.g., a. smart appliance), other smart devices, a web appliance, a network router, a network switch, a network bridge, or any machine capable of executing the instructions 508, sequentially or otherwise, that specify actions to be taken by the machine 500. Further, while only a single machine 500 is illustrated, the term “machine” shall also be taken to include a collection of machines that individually or jointly execute the instructions 508 to perform any one or more of the methodologies discussed herein.

The machine 500 may include processors 502, memory 504, and I/O components 542, which may be configured to communicate with each other via a bus 544. In an example embodiment, the processors 502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency integrated Circuit (RFIC), another processor, or any suitable combination thereof) may include, for example, a processor 506 and a processor 510 that execute the instructions 508. The term “processor” is intended to include multi-core processors that may comprise two or more independent processors (sometimes referred to as “cores”) that may execute instructions contemporaneously. Although FIG. 5 shows multiple processors 502, the machine 500 may include a single processor with a single core, a single processor with multiple cores (e.g., a multi-core processor), multiple processors with a single core, multiple processors with multiples cores, or any combination thereof.

The memory 504 includes a main memory 512, a static memory 514, and a storage unit 516, both accessible to the processors 502 via the bus 544. The main memory 504, the static memory 514, and storage unit 516 store the instructions 508 embodying any one or more of the methodologies or functions described herein. The instructions 508 may also reside, completely or partially, within the main memory 512, within the static memory 514, within machine-readable medium 518 within the storage unit 516, within at least one of the processors 502 (e.g., within the processor's cache memory), or any suitable combination thereof, during execution thereof by the machine 500.

The I/O components 542 may include a wide variety of components to receive input, provide output, produce output, transmit information, exchange information, capture measurements, and so on. The specific I/O components 542 that are included in a particular machine will depend on the type of machine. For example, portable machines such as mobile phones may include a touch input device or other such input mechanisms, while a headless server machine will likely not include such a touch input device. It will be appreciated that the I/O components 542 may include many other components that are not shown in FIG. 5. In various example embodiments, the I/O components 542 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 542 may include biometric components 532, motion components 534, environmental components 536, or position components 538, among a wide array of other components. For example, the biometric components 532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 534 include acceleration sensor components (e.g., accelerometer), gravitation sensor components, rotation sensor components (e.g., gyroscope), and so forth. The environmental components 536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 538 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 542 further include communication components 540 operable to couple the machine 500 to a network 520 or devices 522 via a coupling 524 and a coupling 526, respectively. For example, the communication components 540 may include a network interface component or another suitable device to interface with the network 520. In further examples, the communication components 540 may include wired communication components, wireless communication components, cellular communication components, Near Field Communication (NYC) components, Bluetooth® components (e.g., Bluetooth® Low Energy), Wi-Fi® components, and other communication components to provide communication via other modalities. The devices 522 may be another machine or any of a wide variety of peripheral devices (e.g., a peripheral device coupled via a USB).

Moreover, the communication components 540 may detect identifiers or include components operable to detect identifiers. For example, the communication components 540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as location via Internet Protocol (IP) geolocation, location via Wi-Fi® signal triangulation, location via detecting an NFC beacon signal that may indicate a particular location, and so forth.

The various memories (e.g., memory 504, main memory 512, static memory 514, and/or memory of the processors 502) and/or storage unit 516 may store one or more sets of instructions and data structures (e.g., software) embodying or used by any one or more of the methodologies or functions described herein. These instructions (e.g., the instructions 508), when executed by processors 502, cause various operations to implement the disclosed embodiments.

The instructions 508 may be transmitted or received over the network 520, using a transmission medium, via a network interface device (e.g., a network interface component included in the communication components 540) and using any one of a number of well-known transfer protocols (e.g., hypertext transfer protocol (HTTP)). Similarly, the instructions 508 may be transmitted or received using a transmission medium via the coupling 526 (e.g., a peer-to-peer coupling) to the devices 522.

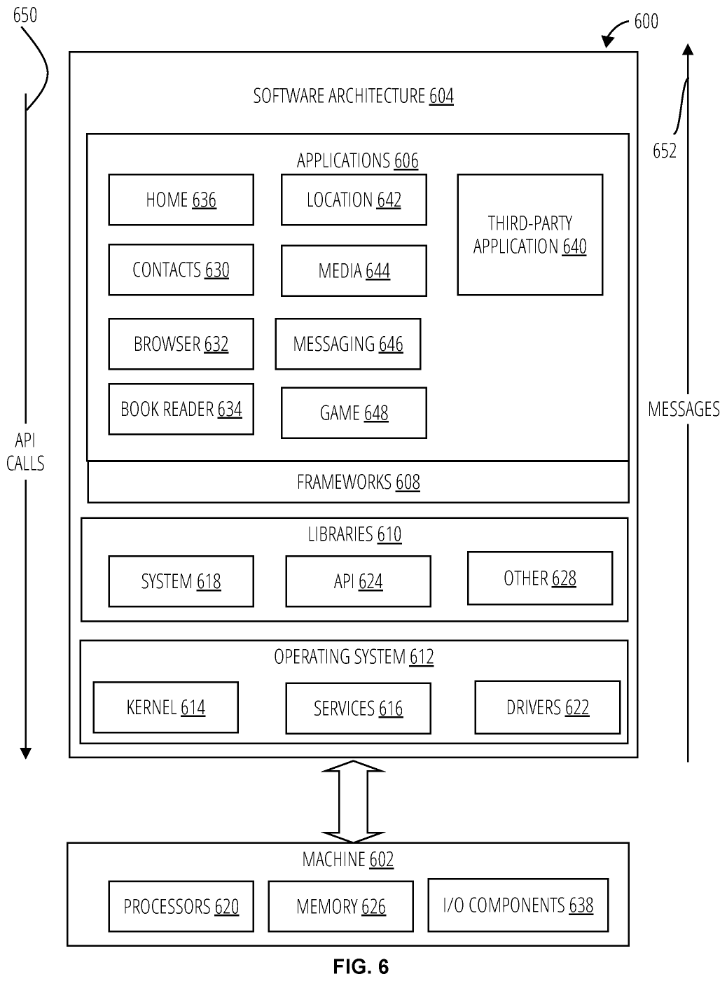

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionality. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 610 provide a low-level common infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or NG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a high-level common infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example embodiment, the applications 606 may include a home application 636, a contacts application 630, a browser application 632, a book reader application 634, a location application 642, a media application 644, a messaging application 646, a game application 648, and a broad assortment of other applications such as a third-party application 640. The e applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROM™, WINDOWS® Phone, or another mobile operating system. In this example, the third-party application 640 can invoke the API calls 650 provided by the operating system 612 to facilitate functionality described herein.

What is claimed is:

1. A method comprising:
receiving, using one or more processors, one or more images of a real-estate property and a value prediction relating to a current value of the real-estate property;
analyzing, using the one or more processors, the one or more images and the value prediction using a machine learning model to generate a value prediction error;
determining, using the one or more processors, that the value prediction error exceeds a predetermined value prediction error threshold; and
based on the determination, computing, using the one or more processors, a final value of the real-estate property by adjusting the value prediction using the value prediction error.

2. The method of claim 1, further comprising:
transmitting, using the one or more processors, the final value to a client device, wherein the final value is displayed on a graphical user interface of the client device.

3. The method of claim 1, wherein the received value prediction is generated by a separate machine learning model trained to generate the value prediction based on quantitative data relating to the real-estate property.

4. The method of claim 1, further comprising:
receiving, using the one or more processors, quantitative data relating to the real-estate property; and
wherein analyzing, using the one or more processors, the image and the value prediction using the machine learning model further comprises analyzing the quantitative data using the machine learning model trained to generate the value prediction error.

5. The method of claim 1, wherein the one or more images of the real-estate property includes a panoramic view of the real-estate property.

6. The method of claim 1, further comprising:
receiving, using the one or more processors, location information for the real-estate property; and
wherein receiving the image includes retrieving the one or more images of the real-estate property from a database using the location information.

7. The method of claim 1, wherein the machine learning model has been pretrained on an image dataset comprising images of real-estate properties.

8. A system comprising:
a memory that stores instructions; and
one or more processors configured by the instructions to perform operations comprising:
receiving, using one or more processors, one or more images of a real-estate property and a value prediction relating to a current value of the real-estate property;
analyzing, using the one or more processors, the one or more images and the value prediction using a machine learning model to generate a value prediction error;
determining, using the one or more processors, that the value prediction error exceeds a predetermined value prediction error threshold; and
based on the determination, computing, using the one or more processors, a final value of the real-estate property by adjusting the value prediction using the value prediction error.

9. The system of claim 8, wherein the operations further comprise:
transmitting, using the one or more processors, the final value to a client device, wherein the final value is displayed on a graphical user interface of the client device.

10. The system of claim 8, wherein the received value prediction is generated by a separate machine learning model trained to generate the value prediction based on quantitative data relating to the real-estate property.

11. The system of claim 8, wherein the operations further comprise:
receiving, using the one or more processors, quantitative data relating to the real-estate property; and
wherein analyzing, using the one or more processors, the image and the value prediction using the machine learning model further comprises analyzing the quantitative data using the machine learning model trained to generate the value prediction error.

12. The system of claim 8, wherein the image of the real-estate property includes a panoramic view of the real-estate property.

13. The system of claim 8, wherein the operations further comprise:
receiving location information for the real-estate property; and
wherein receiving the image includes retrieving the one or more images of the real-estate property from a database using the location information.

14. The system of claim 8, wherein the machine learn model has been pretrained on an image dataset comprising images of real-estate properties.

15. A non-transitory computer-readable storage medium, the computer-readable storage medium including instructions that when executed by a computer, cause the computer to perform operations comprising:
receiving, using one or more processors, one or more images of a real-estate property and a value prediction relating to a current value of the real-estate property;
analyzing, using the one or more processors, the one or more images and the value prediction using a machine learning model to generate a value prediction error;
determining, using the one or more processors, that the value prediction error exceeds a predetermined value prediction error threshold; and
based on the determination, computing, using the one or more processors, a final value of the real-estate property by adjusting the value prediction using the value prediction error.

16. The computer-readable storage medium of claim 15, wherein the operations further comprise:
transmitting, using the one or more processors, the final value to a client device, wherein the final value is displayed on a graphical user interface of the client device.

17. The computer-readable storage medium of claim 15, wherein the received value prediction is generated by a separate machine learning model trained to generate the value prediction based on quantitative data relating to the real-estate property.

18. The computer-readable storage medium of claim 15, wherein the operations further comprise:
receiving, using the one or more processors, quantitative data relating to the real-estate property; and
wherein analyzing, using the one or more processors, the image and the value prediction using the machine learning model further comprises analyzing the quantitative data using the machine learning model trained to generate the value prediction error.

19. The computer-readable storage medium of claim 15, wherein the image of the real-estate property includes a panoramic view of the real-estate property.

20. The computer-readable storage medium of claim 15, wherein the operations further comprise:
receiving location information for the real-estate property; and
wherein receiving the image includes retrieving the one or more images of the real-estate property from a database using the location information.
